(19) United States
(12) Patent Application Publication
(10) Pub. No.: US 2026/0368635 A1
(43) Pub. Date: Nov. 19, 2026

(54) Enforcing Access Controls for Generative Machine Learning Models

(71) Applicant: Oracle International Corporation, Redwood City, CA (US)

(72) Inventors: Virendra J Marathe, Nashua, NH (US); Bargav Jayaraman, Woburn, MA (US); Hamid Mozaffari, Amherst, MA (US); Krishnaram Kenthapadi, Sunnyvale, CA (US)

(21) Appl. No.: 19/567,927

(22) Filed: Mar. 16, 2026

Related U.S. Application Data
(60) Provisional application No. 63/805,837, filed on May 14, 2025.

(51) Int. Cl. G06N 20/00

(52) U.S. Cl. CPC G06N 20/00

(57) ABSTRACT

Systems, methods, and apparaturs to enforce and audit access controls to a generative machine learning model, such as an LLM. An inference request directed to a generative machine learning model may be received. A result to the inference request may be generated by a technique that includes identifying a one or more security domains associated with the inference request, identifying one or more adapters for the generative machine learning model that enforce a content restriction in the result to the one or more security domains, and using the one or more adapters for the generative machine learning model to generate the response to the inference request. The result may then be returned to the inference request.

### RELATED APPLICATIONS

This application claims benefit of priority to U.S. Provisional Application Ser. No. 63/805,837, entitled “ENFORCING ACCESS CONTROLS FOR GENERATIVE MACHINE LEARNING MODELS,” filed May 14, 2025, and which is incorporated herein by reference in its entirety.

### BACKGROUND

Machine learning models provide important decision making features for various applications across a wide variety of fields. Given their ubquity, greater importance has been placed on understanding the implications of machine learning model design and training data set choices on machine learning model performance. Systems and techniques that can provide greater adoption of machine learning models can be, therefore, highly desirable. In enterprise settings, orgamizational data can be seggregated, siloed and carefully protected by elaborate access control frameworks. These access control frameworks may not be reliable if a machine learning model (such as an LLM) fine-tuned on datasets pertaining to different domains, serves requests for downstream tasks from individuals who may not have the access privileges for some or all of the inferences. Systems and techniques that can provide access control such that the inference responses are secure are therefore, highly desirable.

### SUMMARY

Systems, methods, and apparatus to implement enforcing access controls to a generative machine learning model are described herein. An inference request directed to generative machine learning model may be received. A response to the inference request may be generated by a technique that includes identifying one or more security domains associated with the inference request, identifying one or more adapters for the generative machine learning model that are useable to generate a response that is restricted to the one or more security domains, and using the one or more adapters for the generative machine learning model to generate the response to the inference request. The response may then be returned for the inference request.

### BRIEF DESCRIPTION OF THE DRAWINGS

FIG. 1 illustrates an example method of enforcing access control, according to some embodiments.

FIG. 2 illustrates an example method of enforcing access control when one security domain is trained for an adapter, according to some embodiments.

FIG. 3 illustrates an example method of enforcing access control for a series of security domain trained per adapter that are further merged to have one or more security domains per adapter, according to some embodiments.

FIG. 4 illustrates an example method of enforcing access control for one or more security domains trained for an adapter, according to some embodiments.

FIG. 5 illustrates a sample access control table that is used to enforce access control.

FIG. 6 illustrates a flow diagram of a sample access control mechanism that is used to build and deploy a secure generative machine learning model, according to various embodiments.

FIG. 7 illustrates a flowchart that describes a series of steps that implements the secure generative machine learning model, according to various embodiments.

FIG. 8 illustrates a computing system configured to implement the methods and techniques described herein, according to various embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Large Language Models (LLMs) and/or other generative machine learning models, of which an LLM is one example, offer unprecedented natural language processing capabilities. Accordingly, these generative machine learning models are being adopted in a vast range of applications across the entire computing industry. For example, LLMs are routinely used by individuals, both personally and as a part of an organization, for everyday tasks that include information retrieval, content creation, comprehension, summarization, planning, code generation and debugging, education, classification and recommendation, to name a few. In fact, the day may not be too far off in the future when generative machine learning models become the primary interface to a large swath of computing and information extraction tasks.

In various embodiments, in enterprise settings, generative machine learning models are used to perform a wide variety of computing tasks using organization-wide data. Using generative machine learning models that have a wide purview over organizational data can bring massive troves of information and utility, including the ability to combine learnings from disparate information silos of the organization to the fingertips of individuals in the organization. However, making all the learnings from organizational data available to any individual who can query the generative machine learning models becomes a critical security challenge. Organizations have access control structures and hierarchies that tightly control information flow to and from individuals within them. Information access via generative machine learning models, if not carefully controlled, is likely to break down those access control structures and hierarchies.

As an example, consider government agencies using LLMs for a multitude of tasks. The data in government agencies can be segregated among multiple “clearance levels” and users can get access to just the data they have access privileges for. Any other agency data can be inaccessible to the users. An LLM trained on this agency-wide data can leak privileged information to unauthorized users, thus breaking the agency's access control framework that works on the raw data. Another example can be role-based access control: Consider a health clinic setting, where individuals performing different “roles” (doctors, nurses, technicians, administrative staff, patients, etc.) interact with LLMs to perform many tasks. The roles of the users determine what part of the clinic-wide data they should have access to. An LLM trained on the clinic-wide data can be easily tricked into leaking information to unauthorized users.

Proposals to build system prompts that can instruct a generative machine learning model to control what information can be generated in the output can help curb some leakage of sensitive information to unauthorized users. However, they do not achieve absolute security, and clever jailbreaking prompts can be used to overrule these system prompts. Other techniques implement tagging generative machine learning models inference requests with encrypted access credentials to authenticate users and block unauthorized inference requests. However, such techniques lack the flexibility needed to enable access to disparate learnings from the generative machine learning models for different users based on their access credentials. In various embodiments, access control enforcement for agentic systems and Retrieval Augmented Generation (RAG) systems may be implemented.

In various embodiments, challenges to access control enforcement for generative machine learning (GML) models may result from a multitude of data silos, when GML models are trained or tuned on data. Access control enforcement may guarantee that users who do not have access to specific data silos cannot retrieve information from those silos by sending carefully crafted inference requests to the GML trained on data from those silos. To satisfy this guarantee, access control enforcement can be a zero-sum game, so probabilistic solutions are not useable because of the possibility of unauthorized access.

In various embodiments, the notion of an access control mechanism in GMLs may be evaluated in terms of the relevance of responses generated by an GML to inference requests sent by users. In various embodiments, the notion of security domains may be used as a way to describe these techniques. For example, response relevance can be used to prove correctness of access control mechanisms. In various embodiments, metrics called access advantage can be captured to empirically quantify the effectiveness of an access control mechanism on GMLs. As discussed in detail below, the ability to provide access control enforcement, as well as measure its effectiveness, may improve the performance of various systems, services, applications, or devices that implement or otherwise make use of GMLs. As one of ordinary skill in the art may appreciate, the ability to provide and measure effectiveness of an access control mechanism may allow for the use of GMLs in many different scenarios where access control mechanisms are regulatory and/or technical requirement, thus improving the performance of systems, services, application or devices to use of state of the art GMLs.

For example, in various embodiments, the following performance improvements may be achieved, such as a secure generative machine learning (SGML) model—a generative machine learning model that provides access control security for the data ingested through training/tuning, and even through contexts/prompts. The notions of access control and formal metrics may be quantified so that it can be shown that SGML model mechanisms provide access control that satisfy access control guarantees.

In at least one embodiment, a security domain may be a collection of data records that require identical credentials for access (e.g. files with the same group in their access control lists). In at least one embodiment, an SGML model can be configured so that a previously trained machine learning model (e.g., a foundational LLM) can be fine-tuned over data from different security domains with an added constraint to satisfy access enforcement guarantees-responses to inference-time queries may be generated from learnings on data coming from just the security domains the user has access to. This added constraint can be enforced via access control mechanisms that govern how the SGML model uses data from different security domains.

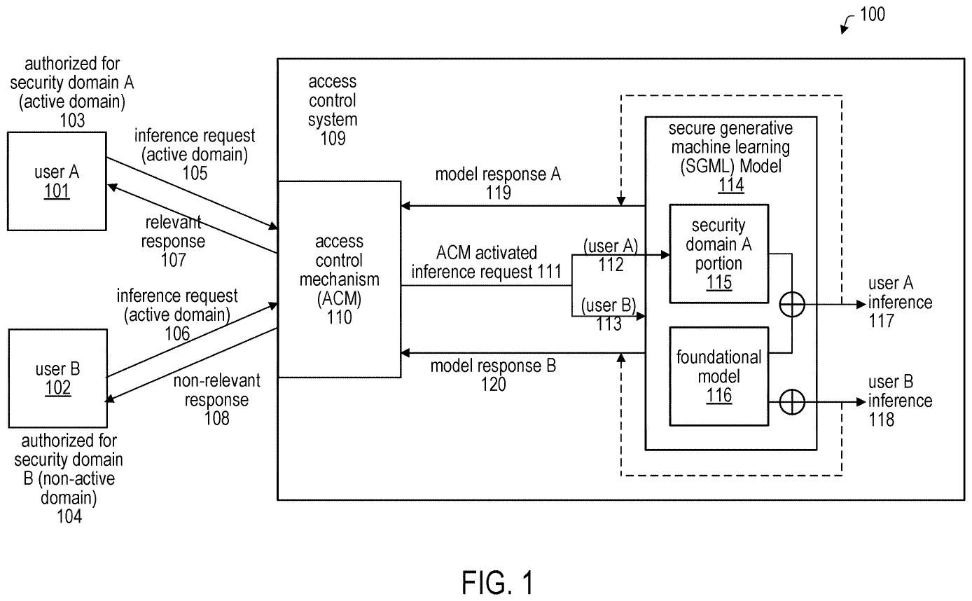

FIG. 1 illustrates a high-level diagram that provides a framework for the use of an SGML model for an access control system 100. The access control system 109 can comprise different security domains. This can be represented mathematically as n different security domains

$$𝕊 = {⋃}_{i = 1}^{n} {s}_{i} .$$

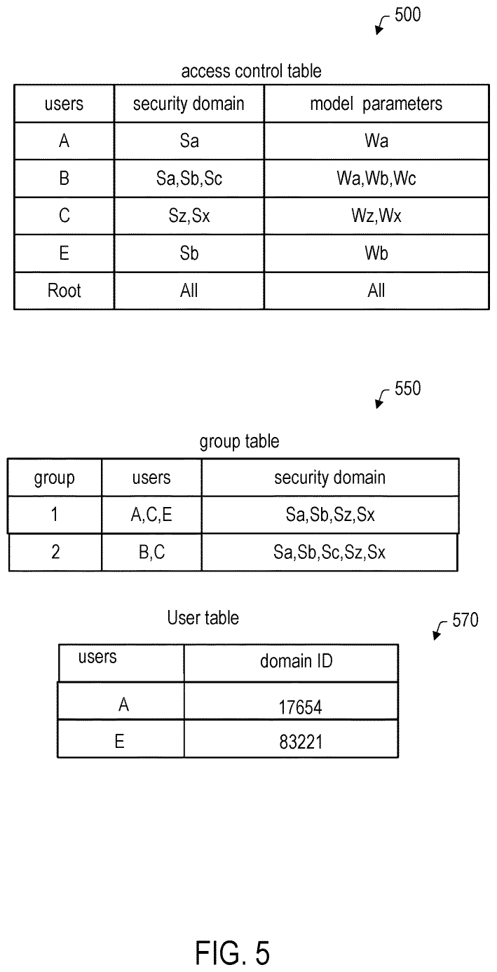

is authorized for security domain B. User A 101 can also be set as an active domain. An active security domain represents the security domain selected for inference while issuing an inference request such as a query or a prompt. In some embodiments, there can be more than be more than one security domain trained per adapter that can represent active domains. The access control mechanism 110 authenticates the user to verify if a user (such as user A or user B) can have access to any of the security domains that can be part of an access control table (such as FIG. 5) for that particular user. For example, FIG. 5 shows that User A is allowed to access security domain Sa. Since User A has access to only one security domain, it can also be selected as the active domain. However, User C has access to security domain Sz and Sx; here either of the security domains (Sz, Sx) can be selected as an active domain. If the user credentials and the active security domain are authenticated based on the access control table, then the inference request can be activated so that the user can be allowed to access the security domain referenced in the inference request.

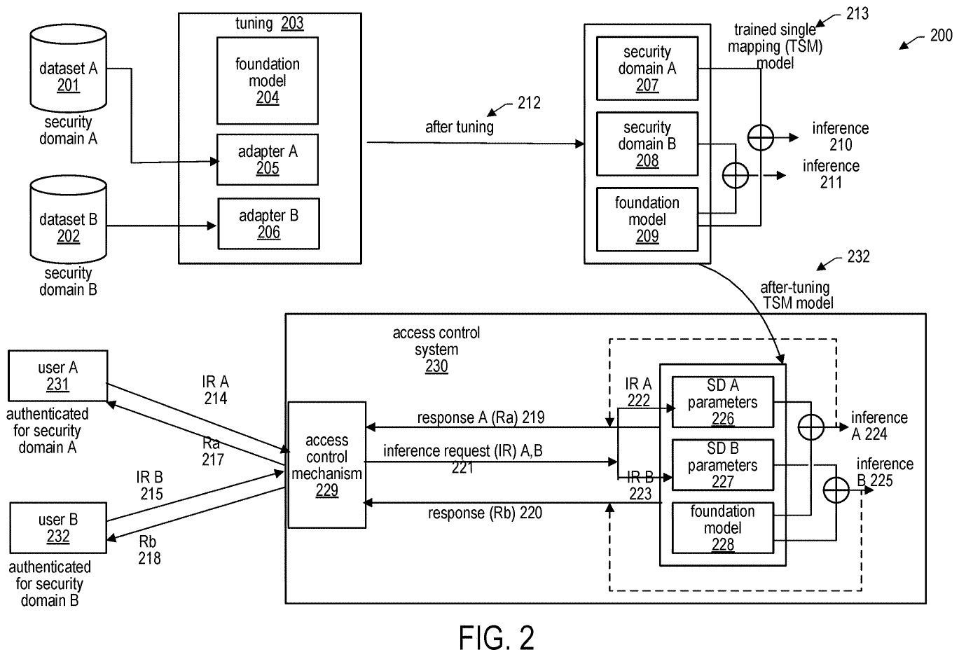

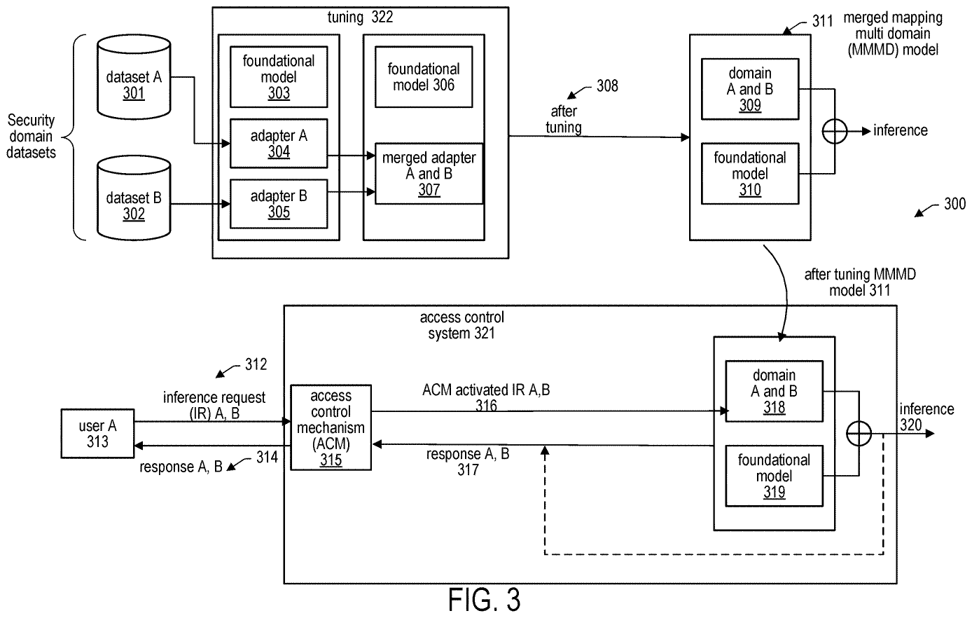

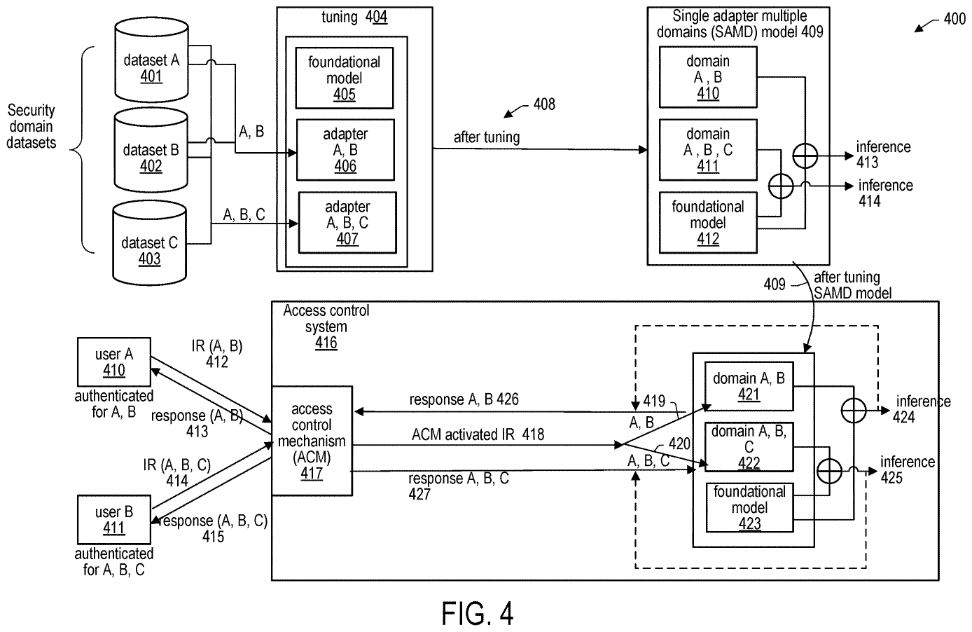

After the user credentials and inference request are authenticated, the access control mechanism 110 then activates the inference request based on the active domain that is selected by enabling the appropriate one or more adapters (discussed more in FIG. 2, FIG. 3, FIG. 4) so that appropriate model parameters are activated. For example, in FIG. 5 for User A, security domain Sa can be the active domain and parameter Wa can be used to generate inference. As shown in FIG. 1, user A 101 is authorized for security domain A which can be configured as an active domain 103. An inference request 105 sent from user A's credentials to the ACM 103 results in looking up an access control table (such as the one illustrated in FIG. 5) and further activating the inference request to security domain A portion of the SGML (112, 115) along with the foundational model 116 to generate an inference 117 for user A, that is relayed as a response (119,107) back to user A. This kind of response may be referred to as a relevant response, as the response is relevant to the active domain.

User B 102 can be authorized for security domain B, but it is a non-active domain, meaning security domain B is not chosen as an active domain for the inference request. If User B sends an inference request for an active domain, the access control mechanism 110 can still authenticate the user B as it can be a valid user; as the user is registered for a valid security domain B 104. However, since the active domain in FIG. 1 can be security domain A, the inference request sent from User B will not activate any of the parameters associated with security domain A 113 and hence will SGML model 114 may generate a response that does not contain any information pertaining to security domain A (118,120,108). Such a response can be said to be a non-relevant response 108. In some embodiments, user B can be an attacker who may try to get inference responses for domains they may not be permitted to access. FIG. 1 illustrates a simple example of an access control system 109 that can provide a secure process for generating inferences. In this example, user B may not be able to receive inferences for security domain A because the access control system may be designed so that only user A is authorized to receive inferences pertaining to security domain A based on inference requests made by user A. However, User B can still receive responses pertaining to foundational model 116 related inferences. In some embodiments, foundational models can be pretrained baseline models that can be readily available such as Mistral, Llama models.

In some embodiments, relevant and non-relevant responses can also be described mathematically. Training data set consisting of data from domains

$$D = {⋃}_{i = 1}^{n} {D}_{{s}_{i}} ∼ 𝒟$$

(here Dₛ_{ᵢ} can be a data set sampled from data distribution Dₛ_{ᵢ} of domain sᵢ). The model f_{D} can be the SGML model tuned using data set D. Parameters W can be the set of f_{D}'s parameters. Model tuning can change values of a subset of W. A security domain sᵢ (such as security domain A 103 in FIG. 1) can affect a subset of parameters Wₛ_{ᵢ}⊆W if data from Dₛ_{ᵢ} can be used to change parameters Wₛ_{ᵢ} (such as 115 in FIG. 1) during model fine-tuning. An access control mechanism M 110 can be defined that dictates the mapping of security domain sᵢ to parameters Wₛ_{ᵢ}. FIG. 5 illustrates an example of such a mapping. A SGML model that can be fine-tuned using data set D can be said to be permissioned, denoted as

$${f}_{D}^{M} ,$$

if it can use the access control mechanism M to map its parameters W to a plurality of security domains from S, where each security domain sᵢ affects parameters Wₛ_{ᵢ}⊆W. Operationally, during fine-tuning, M can specify which set of model parameters Wₛ_{ᵢ} are tuned for a given security domain sᵢ. Similarly, during inference, M can specify which set of model parameters should be used to answer a inference request based on the user's access credentials. SGML model can reside in an enclosing system that authenticates users who send inference requests to

$${f}_{D}^{M} .$$

The system determines the user u's access credentials credᵤ and calls authenticate(credᵤ) that takes user credentials credu and maps them to a subset of security domains Su that u can access. Sᵤ can be maintained by the enclosing system and is never exposed to user u. This process ensures u cannot arbitrarily change Sᵤ. Each of user u's subsequent query qᵤ to

$${f}_{D}^{M}$$

is annotated with Sᵤ by the enclosing system. M 110 determines the model parameters W_{S}_{ᵤ} (such as 115) used to generate a response r_{S}_{ᵤ} (such as 117,119, 107) to qᵤ (such as 105), where W_{S}_{ᵤ}=U_{i∈s}_{ᵤ}Wᵢ.

Mathematically, a relevant request can be described in terms of the mathematical terms defined above. Given a SGML model

$${f}_{D}^{M} ,$$

an inference request qᵤ from user u, and Sᵤ the security domains user u has access to,

$$r = {f}_{D}^{M} ( {q}_{u} )$$

is the response to

$${f}_{D}^{M}$$

to query qᵤ. Response r is said to be relevant to Sᵤ (e.g., r=r_{S}_{ᵤ}) if

$${f}_{D}^{M}$$

uses parameters W_{S}_{ᵤ} to generate r. Similarly, for an inference request qᵤ from user u, and Sᵥ the security domains user u has access to,

$$r = {f}_{D}^{M} ( {q}_{U} )$$

is the response by

$${f}_{D}^{M}$$

to query qᵤ; response r is said to be irrelevant to Sᵥ (e.g., r=r_{S}_{ᵥ} if

$${f}_{D}^{M}$$

does not use parameters W_{S}_{ᵤ} to generate r. In some embodiments, the definition of relevant response that can be expressed mathematically does not exclude additional security domains' affected parameters, as well as pretrained model parameters, from being used in generating the response. We say that an access control mechanism M is correctly enforced on SGML model

$${f}_{D}^{M}$$

if every response r generated for every user query qᵤ is relevant to Sᵤ.

The above definition of relevant response can provide more value if a proposed access control mechanism M can be algorithmically verified, that may require an empirically quantifiable metric to determine if the implementation (and the algorithm by extension) of M can be verified. This can be important for auditing purposes. In some embodiments, a metric called response relevance score, relv

$$( {f}_{D}^{M} ( q ) , {S}_{u} ) ,$$

which quantifies the information gained on data in the security domain q belongs to by observing responses to queries generated using model parameters W_{S}_{ᵤ} affected by security domains of Su. The term relv

$$( {f}_{D}^{M} ( q ) , {S}_{u} ) ,$$

is expected to be higher when q∈DSᵤ, compared to when q∉D_{S}_{ᵤ}.

In some embodiments, the domain of response relevance score may be restricted to the real number interval [0, 1], where 1 is the best expected score for relevance. The response relevance score itself can be represented by another empirical metric such as prediction accuracy, or logits for the expected response. However, given that machine learning models in general are generalization engines, in practice, response relevance scores may be configured to be less than 1. This configuration can be effectively addressed by measuring response relevance scores for security domains that the user has access to and comparing it to response relevance scores for security domains that the user does not have access to. This comparative term can be referred to as an access advantage metric.

Access Advantage can be expressed mathematically as: Given SGML model

$${f}_{D}^{M}$$

trained over data set D consisting of data from domains

$$𝕊 = {⋃}_{i = 1}^{n} {s}_{i} ,$$

with access control mechanism M, a subset of security domains Sᵤ⊆ [symbol] ,

$${f}_{D}^{M}$$

achieves α-access advantage w.r.t. Sᵤ if:

$${E}_{q ∈ {𝒟}_{{S}_{u}} , {S}_{v} ⊆ S : {S}_{u} ⋂ {S}_{v} = ϕ} [ relv ( {f}_{D}^{ℳ} ( q ) , {S}_{u} ) ⊖ relv ( {f}_{D}^{ℳ} ( q ) , {S}_{v} ) ] \geq α$$

where relv( ) is the response relevance score on the corresponding security domain subset (Sᵤ or Sᵥ), θ is a “difference” operator specific to the access control assessment method (e.g. subtraction), and α is an advantage threshold that lies in the range [0,1].

The access advantage metric can rely heavily on the assumption that

$${f}_{D}^{M}$$

performs significantly better on security domains user u has access to compared to security domains u does not have access to. In other words,

$${f}_{D}^{M}$$

may have explicit segregation between the different security domains, as dictated by M. The existing approaches to model fine-tuning fail to achieve this goal as the model is traditionally trained on all the security domains without any built-in domain segregation mechanism, e.g., M=Ø, which can be similar to not having an access control table illustrated in FIG. 5.

In various embodiments, access advantage can be a metric for auditors to determine if an access control mechanism can truly achieve the segregation of security domains as intended. Hence it can be in the auditor's best interest to have a dataset combination that can be closer to the ideal combination, wherein Sᵤ∩Sᵥ=Ø. Access advantage can diminish when Sᵤ∩Sᵥ≠Ø.

In at least some embodiments, retrieval augmented generation (RAG) based LLM deployments explicitly can have effectiveness of access control mechanisms formally or empirically measured. In various embodiments, relevant response and access advantage extends to RAG systems as well, closing that gap in formalism and empirical evaluation of access control protocols.

For evaluating the access control mechanisms, a classic adversarial game can be considered between the system S enclosing the model

$${f}_{D}^{M}$$

and the auditor A. A can choose security domain access by emulating an end user, send arbitrary inference requests to the SGML model via S and observe the responses. A can replay the game multiple times as a different user to conclude if the access control is correctly implemented.

Audit Game. The formal game between auditor A and system S is as follows: Step 1: Auditor [symbol] chooses security domain set Sy and emulates user u. [symbol] sends user credentials cred u and query q∈ [symbol] to system [symbol] . Step 2: [symbol] verifies the user credential credᵤ and sends back the model response

$${f}_{D}^{M} ( q )$$

to [symbol] . Step 3: [symbol] chooses security domain set Sy such that Sᵥ∩Sᵤ=φ and emulates user v. [symbol] sends user credentials credᵥ and the same query q∈ [symbol] to [symbol] . Step 4: [symbol] verifies the user credential credᵥ and sends back the model response

$${f}_{D}^{ℳ} ( q )$$

to [symbol] concludes the access control mechanism is correctly implemented if the access advantage

$$relv ( {f}_{D}^{ℳ} ( q ) , {S}_{u} ) ⊖ r e l v ( {f}_{D}^{ℳ} ( q ) , {S}_{v} ) \geq α .$$

The auditor A can have superuser privileges to choose arbitrary domain access unlike an ordinary user. This can be by design to allow the auditor to evaluate the correctness of the claimed access control while still following the protocol of sending inference requests to the model as a benign user.

In at least some embodiments, Parameter Efficient Fine-Tuning (PEFT) based methods can be used to obtain model parameter segregation for security domains. In some embodiments, LoRA PEFT adapter may be used, but the algorithms mentioned above can be applied to other types of adapters. In some embodiments, PEFT is a method of fine-tuning LLMs. While fine tuning with PEFT, the foundational model of the LLM can be kept the same, and a few trainable adapter components can be inserted into the LLM. The points of placing these adapter components can be carefully chosen, and the net additional weights that are to be trained can be very small compared to sum total of all weights used for the large language model. Comparable results can be obtained by adding a few weights pertaining to the adapters and this can avoid retraining the entire large language model.

The algorithms described herein may steer security domain data to train select adapters. Each security domain can have a unique identifier (domain Id). Access control mechanism can build a map between security domains and adapters such as the access control table discussed above and illustrated in FIG. 5. The access control table can be used to steer all examples from a security domain to the corresponding adapter(s) for training. The access control table can also be used to steer queries to the correct adapters at test time and training time.

In some embodiments, an algorithm can be designed so that one adapter can be mapped to a Security Domain, and that users have access to at most one security domain. FIG. 2 illustrates the base algorithm (referred to as trained single mapping algorithm) that performs a simple 1-1 mapping between security domains and adapters. It may be assumed that the number of security domains is known beforehand and use that knowledge to instantiate corresponding number of adapters. During training, each minibatch can be sampled from one security domain, and the domain's Id can be used to select the adapter to train. At test time, a user's inference request can be annotated with the domain Id the user has access to. The domain Id can be used to activate the adapter for the corresponding security domain.

In some embodiments, an algorithm can be developed so that one or more adapters that each represent one security domain can be merged so that a single adapter that can be used for one or more security domains (referred to as merged mapping multi-domain algorithm hereafter).

Users have access to data from multiple security domains in many application settings, and therefore the one-to-one mapping (such as FIG. 2) may not be practical in many applications. Therefore, merged mapping multi domain (MMMD) algorithm can be developed so that one or more adapters can be merged into a single adapter for one or more security domains. An access control table can have an updated mapping after implementing MMMD algorithm which can be used by the ACM 103 for inference requests. Without using the MMMD algorithm, if the access control table is updated for users to access multiple security domains, queries coming from such users enables all corresponding adapters, whose activations are averaged at test time that tend to disruptively interfere with each other resulting in catastrophic degradation in model performance. Several merging algorithms may be implemented including TIES and DARE, and Singular Value Decomposition (SVD). In at least some embodiments, the combination of security domains that users may have access to may be known beforehand. Thus, after training adapters for individual security domains (as in singular mapping algorithm), the application can be designed to merge adapters for the combinations of security domains known beforehand. Correspondingly, the access control table is updated with the domain IDs and the merged adapters. These new mappings can be used at test time to activate the correct merged adapters for users having access to multiple security domains. In some embodiments, MMMD algorithm can be more robust to cross-adapter interference than activating a plurality of single mapping algorithms, especially when more than two adapters may be merged.

In some embodiments, an algorithm can be developed so that one or more security domains can be trained into a single adapter (can be referred to as single adapter multiple domain algorithm). Thus, each combination of security domains that users have access to can be mapped to a unique adapter. In various embodiments, a security domain can occur in numerous combinations of security domains (e.g. in FIG. 3 one adapter can be configured for security domains A and B, and another adapter can be configured for security domains A, B and C).

In various embodiments, the careful mapping of security domains (or groups of security domains) to the correct adapters and steering of training examples from security domains to the corresponding adapters can ensure precise parameter segregation for security domains. In some embodiments, users cannot tamper with their access credentials at test time further aids the SGML model enclosing system to determine the correct set of security domains corresponding to a query. The inference request steering that happens through the combination of ACM and SGML model that contains an aggregation of adapters trained for different combinations of one or more security domains, guarantees that all responses generated by the SGML model are relevant to the user's security domains.

In some embodiments, FIG. 2 illustrates a single mapping algorithm method that maps a security domain to an adapter in a one-on-one mapping. As discussed earlier, single mapping algorithm maps one adapter to a security domain. During the tuning period 203, each adapter weights (205,206) are tuned for their respective security domains (201,202), so that after tuning 212, there is a trained single mapping (TSM) model 213 that receives requests for a particular security domain (207 or 208), and inference is based on a combination of the respective security domain (207 or 208) and the foundation model 209 as shown in FIG. 2. In some embodiments, the foundation model 209 can be a baseline large language model. For example, after fine tuning adapter A for security domain A (henceforth security domain can be interchangeably used with domain), an inference request pertaining to the TSM model 213 could activate security domain A portion 207 of the TSM model 213 along with the foundation model 209 to generate an inference 210. Similarly, an inference request pertaining to the TSM model 213 could activate security domain B portion 208 of the TSM model 213 along with the foundation model 209 to generate an inference 211. FIG. 2 also illustrates an after-tuning 232 phase, integrated with an access control system 230 wherein multiple users (user A 231, user B 232) are authenticated to an access control mechanism 229. The access control mechanism comprises an access control table that maps the users with the security domains. The access control table can also have other details pertaining to the TSM model such as adapters used, weights trained which can translate inference requests (IR) to activate a specific domain component of the TSM model. FIG. 5 illustrates a sample access control table. For example, user A 231 can send an inference request B 214 to the access control mechanism 229 which activates an inference request 221 to domain B (222,226) and foundational model 228 of the TSM model 232, wherein the TSM model 232 provides a response A (217,219) back to the user B 232. Similarly, user B 232 can send an inference request B 215 to the access control mechanism 229 which activates an inference request to domain B (223,227) and foundational model 228 of the TSM model 232, wherein the TSM model 232 provides a response B (220,218) back to the user B 232.

In some embodiments, FIG. 3 illustrates a merged mapping multiple domain (MMMD) algorithm that initially maps a security domain to an adapter that is later merged into a single adapter based on the credentials of one or more user's access to one or more security domains. As shown in FIG. 3 dataset A 301 can be fine tuned using adapter A 304 and similarly dataset B 302 can be fine tuned using adapter B 305. Once the fine-tuning is satisfied for each of the adapters (A and B), a merge operation is performed to merge the adapters into a single adapter 307 that represents the model parameters for both dataset A 301 and dataset B 302. Prior to merging the adapters A and B, a verification step can be used to ensure that the adapters that are to be merged into a single adapter are based on an access control table that maps a user's access to one or more security domains. FIG. 5 illustrates a sample access control table. The single adapter 307 can be further tested and after the tuning 308 is complete, can result in a merged mapping multiple domain (MMMD) model 311 as shown in FIG. 3. The MMMD model 311 can be integrated into an access control system 321 that comprises an access control mechanism 315 that maps various users that have access to the one or more security domains. A typical user flow is also illustrated in FIG. 3 wherein user A 313 can initiate an inference requests 312 pertaining to dataset A 301 or dataset B 302 or an inference request that pertains to both dataset A and dataset B. An access control mechanism 315 uses an access control table (such as the one illustrated in FIG. 5) to activate the inference request (IR) for the security domains A, B 312 into an ACM activated IR 316 for security domains A,B. The ACM activated inference requests will enable MMMR model to provide an inference response (320, 317,314) based on the single adapter tuned for security domains A and B 318 as well as the baseline foundational model 319.

In some embodiments, FIG. 4 illustrates a single adapter multiple domain (SAMD) algorithm that fine-tunes multiple security domains into a single adapter. As shown in FIG. 4 different security domain sets A, B (401,402) or security domains A, B, C (401, 402, 403) are tuned 404 into a single adapter (A, B) 406 or adapter (A, B, C) 407. As shown in FIG. 4 after fine-tuning 408 is complete, inferences pertaining to security domains A and B are combined with the function model 412 to generate a response 413. Similarly, inferences pertaining to security domains A, B and C are combined with the functional model 412 to generate a response 414. In some embodiments, the combination of adapters that are to be trained can be based on the access control table (as shown in FIG. 5). Based on the access control table the process of tuning 404 the adapters can be decided upfront. The SAMD model can be integrated into an access control system 416 that comprises an access control mechanism 417 that maps users to one or more security domains based on an access control table. A typical user flow is also illustrated in FIG. 4 wherein user A 410 can send inference requests (IR) pertaining to security domains A and B 412 to an ACM 417 that activates the inference request (IR) 418 to domain A,B 419 portion of the SAMD model. As illustrated in FIG. 4 the inference response (424, 426,413) that can be sent back to the user 410 can be a combination of the domain A,B 421 and the functional model 423. In some embodiments, the functional model 423 can be a baseline generative machine model that is readily available such as Llama, Mistral models. Similarly, as illustrated in FIG. 4 an inference request (IR) 414 from user B 411 for domains A, B, C can be sent to an ACM 417 that activates the IR 418 for the pertinent security domains 420 to generate inference (425,427,415) based on domains A, B, C 400 422 as well as the functional block 423 that can be sent to user B 411.

In some embodiments, FIG. 5 illustrates an access control table that maps users to one or more security domains. An access control table 500 is illustrated to have a mapping of users to different security domains along with the model parameters. In some embodiments, the access control table 500 can be generated based on an access control policy. In some embodiments, an access control policy can be a higher level document that illustrates various mappings in an organization that can be used to generate granular tables or sub-policies based on the needs of various departments of an organization. Another table such as a group table 550 is illustrated to have a grouping user into various groups that can further be mapped to access control table 500. Another user table 500 can map users to a unique identifier such as a domain ID as illustrated in FIG. 5. Different tables can be used by different departments in an organization. For example, an infrastructure team can generate users with an ID, associate the users with various groups and generate an unique domain ID for each of the users based on the combination of security domains they are allowed to access, and a development team can have more granular table for fine tuning various adapters that maps the security domains to different model parameters as shown in table 500. Depending on the complexity of the organization and the requirements, in some embodiments, a relational database can be established mapping various relationships to different tables. The access control table can also have other mappings such as the type of adapter that is used. As discussed earlier, many PEFT based adapters such as LoRA adapters can be used to fine-tune machine learning models. The access control table can also have mapping associated with the type of algorithm that can be used to fine-tune the models, such as the algorithms discussed in FIGS. 2, 3 and 4.

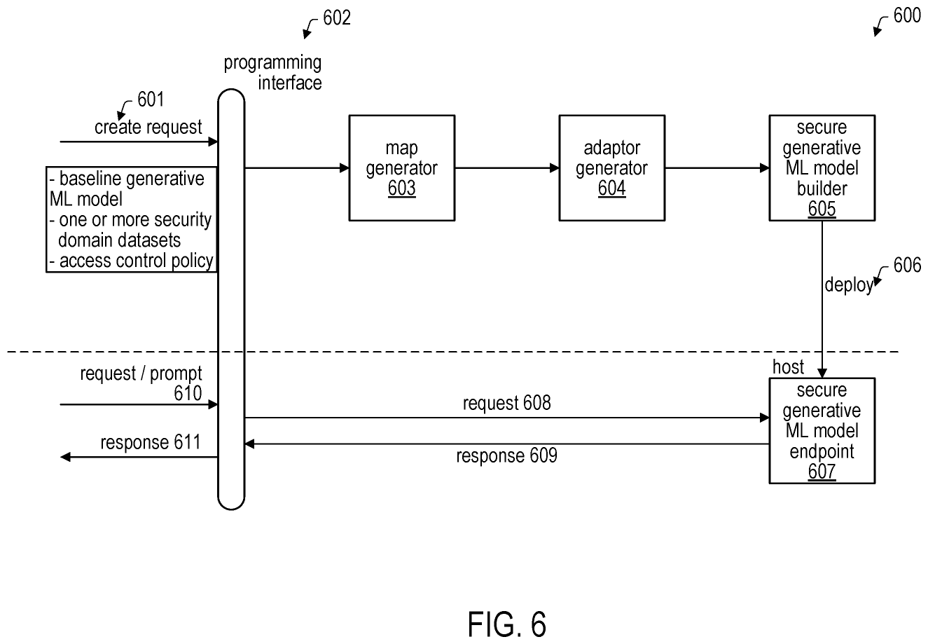

In some embodiments, FIG. 6 illustrates a diagram that entails various components that can be used to build and deploy a secure generative machine learning (SGML) model. The process can start with a create request 601 that can comprise a list of items needed to build and deploy a SGML model. The list of items can include a baseline generative machine learning model, one or more security domain data sets, an access control policy, the type of adapters that can be used to fine-tune the ML model. The access control policy can be derived from various tables pertaining to access control as illustrated in FIG. 5. The create request can be sent through a programming interface 602. Based on the access control policy, the map generator 603 can generate a map of users who may have access to various security domains. This map can further assist in deciding the development team to map various security domains that are to be fine-tuned with adapters. Different algorithms can be used based on the security domain mapping. If it is a single user to a single domain mapping, the adapters can be fine-tuned for just a specific domain. If multiple domains are used by a user, then adapters can be fine-tuned for multiple domains for the user. The adaptor generator 604 uses the map generated by the map generator 603 to generate a plurality of adapters based on the user, security domain mappings.

Different algorithms, such as the ones discussed in FIGS. 2,3 and 4 can be used to generate different adapter combinations based on the security domains that need to be trained. Once the model parameters are fine-tuned for various adapters, the last step involves building the final model 605 that can include using a training data set to train the model and further verifying the training dataset with a test dataset. Different kinds of datasets can be used based on the application specific use-case. In some embodiments datasets such as WMDP, GPQA, SimpleQA, RCVI can be used to train and test the models. In some embodiments, different kinds of baseline machine learning models can be used to add the adapters. Different kind of metrics can be used to assess the working of the models. In some embodiments, the loss gap which is the difference between the inference data during testing and training can be measured, across different datasets as well as across different baseline models, and different SGML models.

In some embodiments, a table can be generated to assess how the loss gap compares across different datasets, different trained models (which is a combination of baseline models and the adapters) and also across different types of algorithms used to train the models. For example, the SGML model discussed herein can be compared with a fully trained baseline machine learning model, wherein all the parameters are retrained. The results can further be verified by an auditor with metrics discussed above. If the results of the SGML model trained with a few adapters (based on the security domains and user mappings) are comparable to a fully retrained baseline model, then the SGML model can be ready to be deployed 607 in a provider network as an endpoint. In some embodiments, a provider network can be a cloud computing service provider that provides various tools and resources needed to deploy the SGML model endpoint. In some embodiments, the deployed SGML endpoint can include compute instances specialized for the SGML model, load balancers, container management services, databases so that the application can scale based on the request/response workloads. After the SGML endpoint is deployed, the application can be ready to serve inference requests at scale, and the SGML endpoint 607 can receive requests at scale and respond with inference responses at scale.

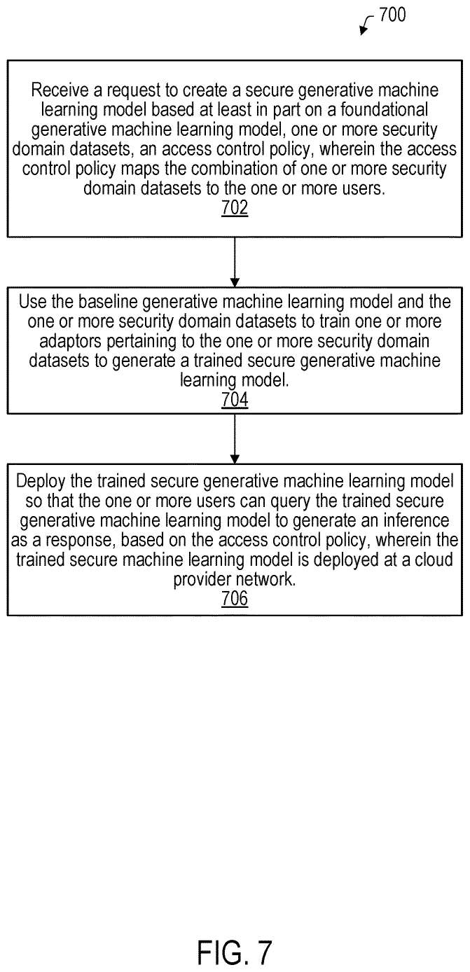

In some embodiments, FIG. 7 illustrates a flowchart that describes the steps used to build and deploy a secure generative machine learning (SGML) model, similar to the techniques discussed above with regard to FIG. 6. The process can start with 702, receiving a request to create a secure generative machine learning model based at least in part on a foundational generative machine learning model, one or more security domain datasets, an access control policy, wherein the access control policy maps the combination of one or more security domain datasets to the one or more users. Based on the request, 704 use the generative machine learning model and the one or more security domain datasets to train one or more adaptors pertaining to the one or more security domain datasets to generate a trained secure generative machine learning model. After training and testing the SGML model, 706 deploy the trained SGML model so that one or more users can query the trained SGML model to generate an inference that can be sent to the user as a response, based on the access control policy, wherein the trained SGML model is deployed at a cloud provider network.

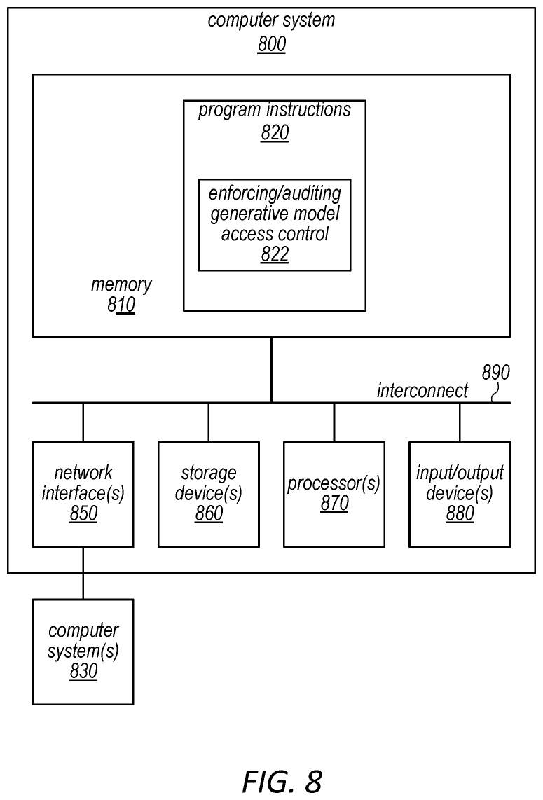

FIG. 8 illustrates a computing system configured to implement the methods and techniques described herein, according to various embodiments. The computer system 800 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing subject level privacy attack analysis for federated learning, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 800 may include one or more processors 870; each may include multiple cores, any of which may be single or multi-threaded. Each of the processors 870 may include a hierarchy of caches, in various embodiments. The computer system 800 may also include one or more persistent storage devices 860 (e.g. optical storage, magnetic storage, hard drive, tape drive, solid state memory, etc.) and one or more system memories 810 (e.g., one or more of cache, SRAM, DRAM, RDRAM, EDO RAM, DDR 10 RAM, SDRAM, Rambus RAM, EEPROM, etc.). Various embodiments may include fewer or additional components not illustrated (e.g., video cards, audio cards, additional network interfaces, peripheral devices, a network interface such as an ATM interface, an Ethernet interface, a Frame Relay interface, etc.)

The one or more processors 870, the storage device(s) 850, and the system memory 810 may be coupled to the system interconnect 840. One or more of the system memories 810 may contain program instructions 820. Program instructions 820 may be executable to implement various features described above, including enforcing and/or auditing access controls to generative machine learning models and other techniques 822 as discussed above, in some embodiments as described herein. Program instructions 820 may be encoded in platform native binary, any interpreted language such as Java™ byte-code, or in any other language such as C/C++, Java™, etc. or in any combination thereof.

In one embodiment, Interconnect 890 may be configured to coordinate I/O traffic between processors 870, storage devices 860, and any peripheral devices in the device, including network interfaces 850 or other peripheral interfaces, such as input/output devices 880. In some embodiments, Interconnect 890 may perform any necessary protocol, timing or other data transformations to convert data signals from one component (e.g., system memory 810) into a format suitable for use by another component (e.g., processor 870). In some embodiments, Interconnect 890 may include support for devices attached through various types of peripheral buses, such as a variant of the Peripheral Component Interconnect (PCI) bus standard or the Universal Serial Bus (USB) standard, for example. In some embodiments, the function of Interconnect 890 may be split into two or more separate components, such as a north bridge and a south bridge, for example. In addition, in some embodiments some or all of the functionality of Interconnect 890, such as an interface to system memory 810, may be incorporated directly into processor 870.

Network interface 850 may be configured to allow data to be exchanged between computer system 800 and other devices attached to a network, such as other computer systems, or between nodes of computer system 800. In various embodiments, network interface 850 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 880 may, in some embodiments, include one or more display terminals, keyboards, keypads, touchpads, scanning devices, voice or optical recognition devices, or any other devices suitable for entering or retrieving data by one or more computer system 800. Multiple input/output devices 880 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 850.

Those skilled in the art will appreciate that computer system 800 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 800 may also be connected to other devices that are not illustrated or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to:
receive an inference request directed to a generative machine learning model;
generate a result for the inference request, wherein to generate the result, the program instructions cause the at least one processor to:
identify a one or more security domains associated with the inference request;
identify one or more adapters for the generative machine learning model that enforce content restrictions in the result to the one or more security domains; and
use the one or more adapters for the generative machine learning model to generate the result; and
provide the result of the inference request.

2. The system of claim 1, wherein the one or more adapters have a one-on-one mapping with the one or more security domains for the generative machine learning model.

3. The system of claim 1, wherein the one or more adapters have a one-on-one mapping with the one or more security domains that are merged into a merged adapter that has one-to-many mapping with the one or more security domains for the generative machine learning model.

4. The system of claim 1, wherein the one or more adapters are trained to have a one-to-many mapping with the one or more security domains for the generative machine learning model.

5. The system of claim 3, wherein the merging of the one or more adapters that have a one-to-one mapping with the one or more security domains into the merged adapter is performed using Singular Value Decomposition (SVD).

6. The system of claim 1, wherein the one or more adapters are mapped to the one or more security domains based at least in part on an access control table that comprises a mapping of one or more users to one or more security domains.

7. The system of claim 6, wherein the inference request received from a user, activates the one or more adapters based at least in part on the access control table that comprises a mapping of the user to one or more security domains.

8. A computer-implemented method, comprising:
receiving an inference request directed to a generative machine learning model;
generating a result for the inference request, wherein to generate the result:
identifying a one or more security domains associated with the inference request;
identifying one or more adapters for the generative machine learning model that enforce content restrictions in the result to the one or more security domains; and
using the one or more adapters for the generative machine learning model to generate the result; and
providing the result of the inference request.

9. The method of claim 8, wherein the one or more adapters have a one-on-one mapping with the one or more security domains for the generative machine learning model.

10. The method of claim 8, wherein the one or more adapters have a one-on-one mapping with the one or more security domains that are merged into a merged adapter that has one-to-many mapping with the one or more security domains for the generative machine learning model.

11. The method of claim 8, wherein the one or more adapters are trained to have a one-to-many mapping with the one or more security domains for the generative machine learning model.

12. The method of claim 10, wherein the merging of the one or more adapters that have a one-to-one mapping with the one or more security domains into the merged adapter is performed using Singular Value Decomposition (SVD).

13. The method of claim 8, wherein the one or more adapters are mapped to the one or more security domains based at least in part on an access control table that comprises a mapping of one or more users to one or more security domains.

14. The method of claim 13, wherein the inference request received from a user, activates the one or more adapters based at least in part on the access control table that comprises a mapping of the user to one or more security domains.

15. One or more non-transitory, computer-readable storage media, storing program instructions that when executed on or across one or more computing devices, cause the one or more computing devices to implement:
receiving an inference request directed to a generative machine learning model;
generating a result for the inference request, wherein to generate the result:
identifying a one or more security domains associated with the inference request;
identifying one or more adapters for the generative machine learning model that enforce content restrictions in the result to the one or more security domains; and
using the one or more adapters for the generative machine learning model to generate the result; and
providing the result of the inference request.

16. The one or more non-transitory computer-readable storage media of claim 15, wherein the one or more adapters have a one-on-one mapping with the one or more security domains for the generative machine learning model.

17. The one or more non-transitory computer-readable storage media of claim 15, wherein the one or more adapters have a one-on-one mapping with the one or more security domains that are merged into a merged adapter that has one-to-many mapping with the one or more security domains for the generative machine learning model.

18. The one or more non-transitory computer-readable storage media of claim 15, wherein the one or more adapters are trained to have a one-to-many mapping with the one or more security domains for the generative machine learning model.

19. The one or more non-transitory computer-readable storage media of claim 15, wherein the one or more adapters are mapped to the one or more security domains based at least in part on an access control table that comprises a mapping of one or more users to one or more security domains.

20. The one or more non-transitory computer-readable storage media of claim 19, wherein the inference request received from a user, activates the one or more adapters based at least in part on the access control table that comprises a mapping of the user to one or more security domains.
